(19) United States
(12) Patent Application Publication
(10) Pub. No.: US 2008/0082567 A1
(43) Pub. Date: Apr. 3, 2008

(54) Apparatuses, Methods And Systems For Vector Operations And Storage In Matrix Models

(76) Inventor: Jeffrey Werner Bezanson, Brighton, MA (US)

Correspondence Address: CHADBOURNE & PARKE LLP, 30 ROCKEFELER PLAZA, NEW YORK, NY, 10112, US

(21) Appl. No.: 11/742,695

(22) Filed: May 1, 2007

Related U.S. Application Data
(60) Provisional application No. 60/746,093, filed on May 1, 2006.

(30) Foreign Application Priority Data
May 1, 2007 (US) PCT/US2007/067866

(51) Int. Cl. G06F 17/30; G06F 3/048

(52) U.S. Cl. 707/102; 715/781; 707/E17.005

(57) ABSTRACT

The disclosure details the implementation of apparatuses, methods, and systems for a vector operator. In one embodiment, a virtual data object is established by a user requesting that operations are performed on a subset of an existing and/or specified parent data object. In one embodiment, the vector operator automatically makes optimizations when it notices that the requested subset of a larger parent data object falls within the bounds of the parent data object. The vector operator may employ slice and arbitrary subvector optimizations. These optimizations work transparently for users that employ the vector operator's user interface. As such, the vector operator avoids creating a new data object of the appropriate size, and avoids copying data from the old matrix into the new one. As such, the vector operator's integrated programming interface makes it easier to generate operations (e.g., write algorithms) affecting slices or submatrices. A user does not need to bother writing code to do the necessary bookkeeping of tracking where a slice belongs within a larger dataset nor does the user need to know the underlying data representation to preserve maximum performance; the vector operator handles this automatically. In addition, a distributed vector operator allows data sets to be broken into specified pieces and/or regions, to be transferred across a network, to be operated upon in a distributed manner by other computers, and finally returned to the originating computers. In so doing, the vector operator analyzes data ranges of requests it receives from other computers, and sends out requested data. However, only as little of the requested data as is necessary is ever transferred, while the remainder of the parent data object's data is not transferred.

This application claims priority to U.S. provisional application Ser. No. 60/746,093 filed May 1, 2006, titled “Apparatuses, Methods and Systems for Vector Operations and Storage in Matrix Model,” which is hereby incorporated by reference.

### FIELD

The present invention is directed generally to apparatuses, methods, and systems of numerical computing, and more particularly, to apparatuses, methods and systems to access, calculate, generate and store vectors in matrix models.

### BACKGROUND

Computerized programming languages and numerical computing tools have been used to perform arithmetic, linear algebra and numerical analysis computations. These tools employ various algorithms, which can be used to solve certain types of continuous and discrete mathematics problems. Numerical computing tools, often, aid those working in the scientific and engineering fields. MathWorks' MATLAB is an example of a numerical computing tool.

### SUMMARY

The disclosure details the implementation of apparatuses, methods, and systems to access, calculate, generate and store vectors in matrix models (hereinafter a “vector operator”). Prior to the inventive aspects of the present disclosure, it was not possible to access, calculate, generate and manipulate vectors in matrix models in an easy and efficient manner.

Existing high-level programming languages (such as Java, Python, Ruby, MATLAB, Maple, Mathematica, and some LISP dialects) provide an opaque matrix or vector data type. In such systems, the only way to use a submatrix or slice is to create a new matrix of the appropriate size, and copy data from the old matrix into the new one. After some processing, it may be necessary to copy results back into the old matrix. This arrangement adds a large amount of overhead due to the time taken allocating memory and needlessly copying data. Yet, in scientific and engineering applications it is frequently necessary to operate on a section of a large dataset. For example, one might need to apply a 2-dimensional image processing algorithm to a single slice of a 3-dimensional dataset; conventionally, this would incur the large overhead of copying and using large amounts of memory in interacting with the single slice of data.

The present disclosure details mechanisms that offer enormous performance and operational enhancements in numerous applications, in part, by eliminating this overhead. Another benefit of the vector operator is that this performance is integrated with a programming interface that makes it easier to generate operations (e.g., write algorithms) affecting slices or submatrices. A user does not need to bother writing code to do the necessary bookkeeping of tracking where a slice belongs within a larger dataset nor does the user need to know the underlying data representation to preserve maximum performance; the vector operator handles this automatically.

In accordance with certain aspects of the disclosure, the above-identified problems are overcome and a technical advance is achieved in the art of numerical computing.

### BRIEF DESCRIPTION OF THE DRAWINGS

The accompanying appendices and/or drawings illustrate various non-limiting, example, embodiments and inventive aspects in accordance with the present disclosure:

FIG. 1 is of a block diagram illustrating computational operations employing the vector operator;

FIG. 2 is of a logic flow diagram illustrating an application interface for a vector operator;

FIG. 3 is of a block diagram illustrating vector operator submatrix storage types;

FIG. 4 is of a logic flow diagram illustrating the vector operator's determination of optimization;

FIG. 5 is of a logic flow diagram illustrating the vector operator's slice optimization;

FIG. 6 is of a logic flow diagram illustrating the vector operator's arbitrary vector optimization;

FIG. 7 is of a block diagram illustrating the vector operator in a distributed environment;

FIG. 8 is of a block diagram illustrating a vector operator controller;

APPENDIX 1 is a partial list of a vector operator application programming interface.

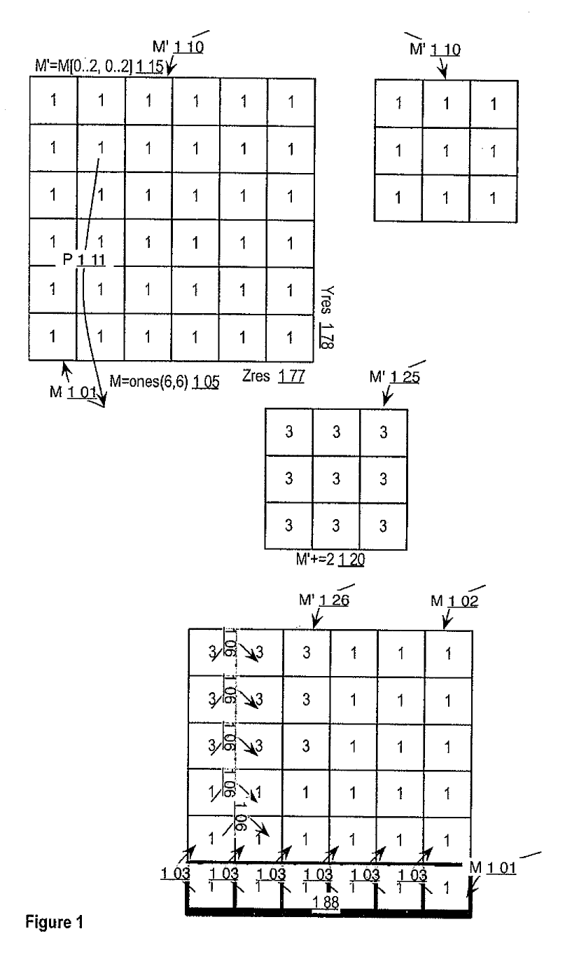

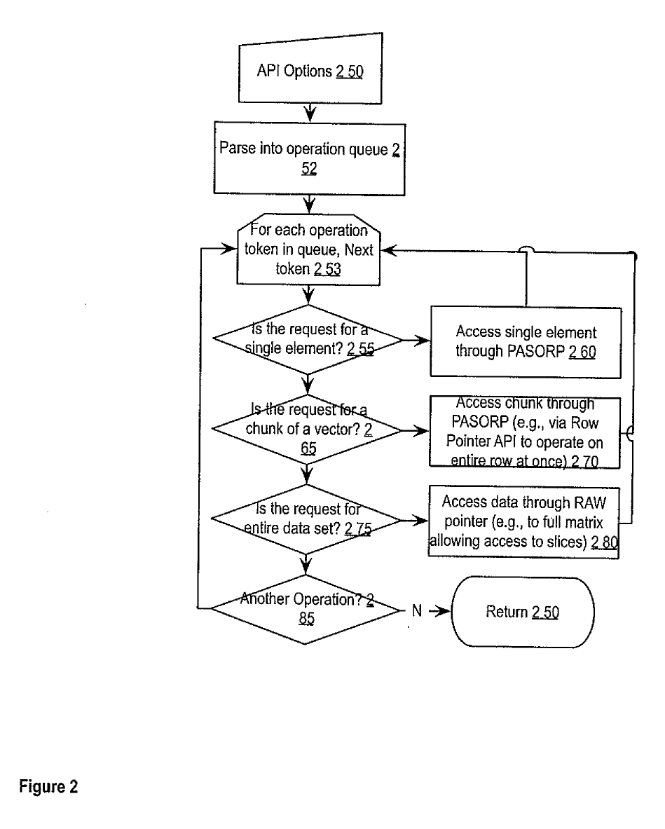

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

Vector Operator

The present disclosure illustrates inventive aspects of vector operations and storage in a matrix model (hereinafter “vector operator”). In order to provide a clearer picture of the disclosed technology, it is useful to provide several examples of a computational operator that may be made more efficient with the vector operator.

Data Object Juxtaposition

FIG. 1 is of a block diagram illustrating computational operations employing the vector operator. In one embodiment, a programming interface is employed in which an expression referring to part of a dataset M 101 (i.e., an original data object; e.g., in this case, a matrix) results in a seemingly new, independent data object M′ 110 (i.e., a submatrix) whose contents are actually part of a larger dataset. It should be noted that throughout this disclosure, the terms dataset, data object, data structure, matrix and vector may be used interchangeably, generally, to refer to an N-dimensional grid of numbers. As such, a subvector, submatrix, etc., generally, may refer to a contiguous rectangular subset of a vector. In the case when interacting with data objects, references to data may be made. As such, in those cases a reference is a handle providing access to some object in a high-level language. For example, a reference subvector is an object in the programming system of the vector operator that refers to part of a vector in-place; e.g., a reference submatrix is a reference subvector having only 2 dimensions.

To the user, the creation of the new subvector is transparent and easy as the vector operator performs the difficult job of determining how to create and instantiate this kind of virtual data object. A sequence of operations demonstrates the resulting commingled identifiers.

Initially, a data object, e.g., a matrix, may be created and populated with a value of one as such:
M=ones(6,6)105
Where operand M 101 identifies the initial data object; “=” denotes an operation where the data object M is to be identified with the resulting operation; “ones” represents a operator to establish a matrix with element values being set to one; and “(6,6)” represents a parameter value for the “ones” operator, whereby the “ones” operator will form a 36 element matrix having a 6 unit long X Cartesian dimension, by a 6 unit long Y Cartesian dimension 105. In one embodiment, these dimensions may be accessed by employing row order referencing, i.e., with index references ranging from 0 to 5.

Another seemingly new data object may be established as a submatrix or child, M′, of the original parent matrix M as such:
M′=M[0 . . . 2, 0 . . . 2]115
Where operand M′ 110 identifies the child data object; “=” denotes that the child data object M′ is to be identified with the resulting operation; “M[0 . . . 2, 0 . . . 2]” represents a 3-unit-by-3-unit matrix subset address space 110 of the original parent matrix data object M 101.

Once the child data object M′ is instantiated, any number of operations may be performed orthogonally on either the parent M or child M′. For example, the following operation adds a value of two across existing values of the child matrix M′ as such:
M′+=2 120
Where operand M′ 110 identifies the child data object; “+=” denotes an operation where the addition of a subsequent parameter value is to be added across the child's rage of values; and “2” is the parameter value to be used by the operation. As a result, the child data object M′, which consisted of a matrix having unitary elements with a value of “1,” had its unitary values increased by “2” resulting in M′ having unitary elements all with the value of “3” 125. Yet, in reality, the child data object M′ 126 is held within the bounds of the original parent data object M's address space 102. One advantage of this embodiment is that no extra memory is used, except for a negligible overhead of the reference object M′ itself, as the child M′ is a part of the of the parent's M space. Another advantage of this embodiment is that changes to the child M′ automatically propagate to the parent structure M, i.e., the conventional data flow overhead (i.e., of allocating extra memory for an additional data objects, copying data to the new location and back to the original location) is avoided.

As shown above and will be discussed in greater detail below, the vector operator provides a scheme for representing metadata objects that describes datasets, and this in turn, allows the vector operator to take advantage of special cases to minimize the amount of metadata required. For example, when all dimensions smaller than a certain dimension are the same size in the subvector as in the parent, it is not necessary to allocate slice pointers for those dimensions (pointers from the parent are reused). In one embodiment, a single pointer suffices, and is allocated along with the metadata object itself to save time and space. Also, when a subvector is positioned flush against the “left side” of the dataset (i.e., when x=0), it is not necessary to allocate new row pointers. In such a case, row and slice pointers for the new subvector would refer to specific ranges of existing row pointers in the parent vector.

Data and Metadata Representation

In one embodiment, the vector operator lays out a dataset contiguously in memory. Several representations are possible, but to simplify presentation row-major order will be used throughout the disclosure. In this representation, the first row of the first slice of a dataset is stored with successive elements at increasing memory addresses. Then successive rows are stored until the first slice is complete, then the next slice is stored in the same fashion, and so on. Column-major order could also be used, in which elements down a column are stored at successive increasing memory addresses.

In one embodiment, all operations on the data are performed through a metadata object to which the user of the vector operator (e.g., in a programming system) holds a reference. For simplicity, we will assume datasets are no more than 3-dimensional (X by Y by Z), although the technique generalizes to N dimensions.

The metadata object includes:

1. A pointer to the beginning of the data (the “raw pointer”) M 101.

2. The size of each dimension; e.g., the zres dimension being 6 units wide 177 and yres dimension being 6 units tall 178.

3. A pointer to a parent vector 111. If the vector is not a reference subvector, this is a self-pointer (i.e., a pointer to the same object that contains it).

4. An array 188 of Z slice pointers 103, each of which points to an array of Y row pointers 106 (i.e., a pointer to a structure of row pointers (PASORP)), each of which points to a sequence of X elements within the linear data layout.

5. Two extra pointers that may be used to represent the Y and/or Z dimensions when Y is unit size or both Y and Z are unit size

6. The numeric type of the data points (for example, 32-bit signed integer, complex float, 16-bit unsigned integer, etc.)

In one embodiment, items 4 and 5 could be replaced by storing offsets into the parent for each dimension instead. Any position in the subvector can be reached with this information along with the parent sizes (accessible through the parent pointer). This alternate implementation provides the same behavior with different performance tradeoffs. The alternate representation is also easier to serialize into a byte stream (e.g., for saving to stable storage or sending over a network) because it does not rely as heavily on pointers to locations in a certain machine's memory at a certain time. Indeed, the metadata for a reference subvector should be converted to this format for serialization regardless of the representation that is used for in-memory objects. Such data representations and mechanisms have the advantage of working well in a garbage-collected environment, ensuring that referenced data is always available without leaking memory. With this data representation in place, we may move to detail and implement the operations of data access (read/write) and reference subvector creation.

Data Access

In one embodiment, any individual point in any vector or subvector can be accessed by looking up a row pointer using the Y and Z coordinates, then taking the X^{th} element of that row. Operations on data frequently need to access many nearby points, and in such a case, requesting each point individually is inefficient. A programmer extending the vector operator may request a row pointer for given Y and Z coordinates, and index it repeatedly to access elements at varying X coordinates. In the case of a slice, the programmer may request a raw pointer that can be used to access the entire dataset efficiently as a linear array.

API Flow

FIG. 2 is of a logic flow diagram illustrating an application interface for a vector operator. The vector operator is capable of these numerous advantages, in part, through a provided application programming interface (API). The vector operator makes use of several optimizations (that will be discussed in further detail below) to achieve these and other advantages while making the use of such optimizations transparent to the user through the API. The API accepts any number of requested operations/options 250 (a partial list of which may be seen in Appendix 1) and parses the supplied computational request into a parsed token, which is placed in queue for review 252. Each token in the queue 253 is then evaluated by the vector operator to determine what, if any, optimizations may be achieved 255, 265, 275, 285.

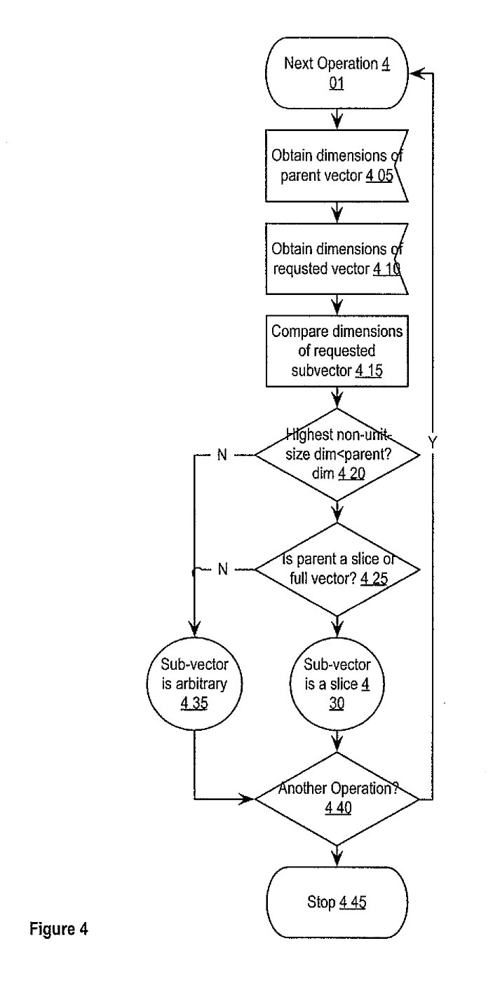

As part of the parsing, the vector operator examines the ranges of data being affected by the user operation. In so doing, the vector operator may perform a collision detection to determine if the range supplied by the user is a) within a supplied parent data object, and b) if the data range is i) a single element 255, ii) a chunk or subset of the parent 265, and iii) if the range includes the entire data set of the parent 275. In one embodiment, such collision detection may be performed by determination component, which may determine if any range offsets are within the range of the parent data object. This determination may be achieved by adding the range indices to any supplied base address and ensuring that the resulting address is not beyond the bounds of the parent address space (see FIG. 4 for some embodiments of collision detection). If the token is understood to be a request for a single element 255, then the vector operator will access the single element through a pointer to a structure of row pointers 260. Row pointers are memory addresses at the start of one row of data. After such access 260, the vector operator may continue examining tokens 253.

However, if the token is not a request for a single element 255, then the vector operator determines if it is a request for a chunk of a vector 265. A chunk contains more than a single data element. If a chunk is requested, then the vector operator will access the chunk through a PASORP; e.g., via a row pointer API one could operate on an entire row at once) 270. After such access 270, the vector operator may continue examining tokens 253.

However, if the token is not a request for a chunk of a vector 265, then the vector operator determines if it is a request for an entire data set 275. If an entire data set is requested, then the vector operator will access the that data set through a raw pointer to the dataset 280. A raw pointer is the memory address of the first data element of a vector where the entire vector is linearly contiguous in memory. After such access 280, the vector operator may continue examining tokens 253.

However, if the token is not a request for an entire data set 275, then the vector operator determines if there are other tokens in the queue 285, and if so, it will continue examining tokens 253; otherwise the vector operator will return control 250 to any component which may have called upon the vector operator, is designated a delegate of the vector operator, and/or is designed to accept control from the vector operator.

Submatrix Storage Cases

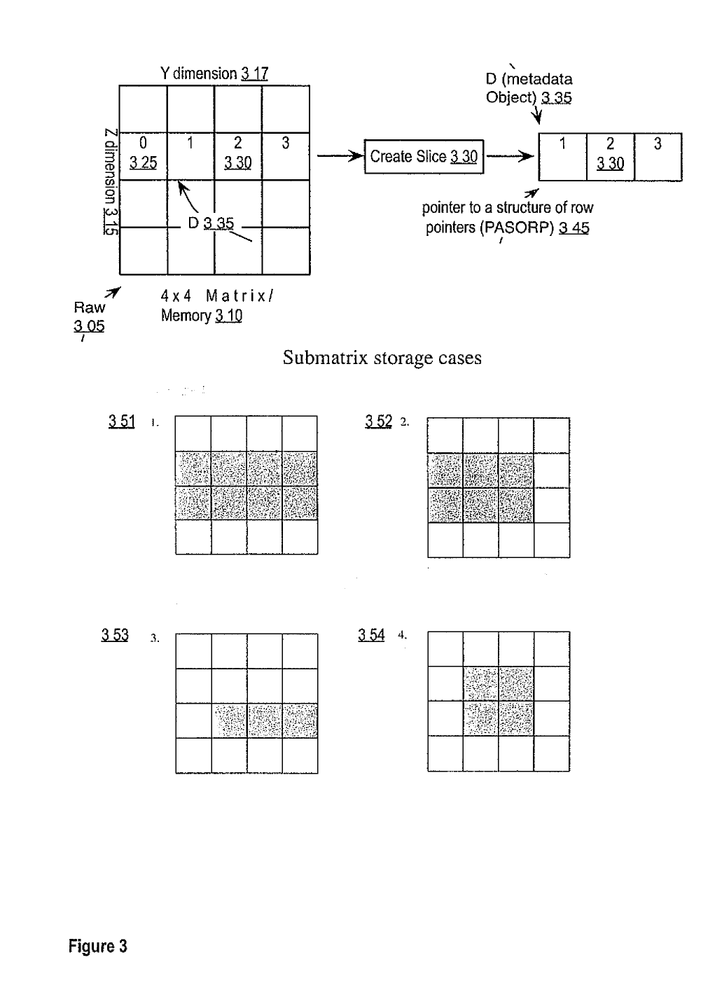

FIG. 3 is of a block diagram illustrating vector operator submatrix storage types. In general, an initial data object may be created 310. Although the vector operator may work with many different data object structures, for purposes of eased understanding, a 4×4 unit matrix may be employed to show the various types of data storage that may be employed by the vector operator. As such, an initial data object, once created, will be referenced by a raw pointer 305. For example, an operation such as “M=ones(4,4)” would result in a matrix occupying 4×4 units of memory 310 and where M would act as a raw pointer 305 to the data object, i.e., to that memory space. In this case, as the data object is two dimensional, we can view it as having a Z dimension axis 315 and a Y dimension axis 317. Data elements may be accessed through the raw pointer 305. Upon creating an initial data object, an operation can be performed to create a child data object, e.g., an API operation that creates a slice 330 resulting in the child metadata object “D” 335. In effect, the child metadata object identifier “D” 335 is a PASORP 345, which can be used in accessing the resulting slice 330.

Numerous variations on optimized storage are available via the vector operator. In some embodiments, the optimizations of reusing parent row pointers may take place when the child object shares the initial column's row pointers 351, 352. In showing several examples, an original 4×4 matrix exists and a new/child submatrix that is to be created is shown in grey. In one embodiment, when creating a slice submatrix 351, row pointers from a parent data object may be reused (i.e., because the “left most” column is shared) and a raw pointer will be available because the elements of the submatrix are linearly contiguous in memory. Here the new submatrix will share a slice that spans from the original matrix's columns (but occupies only the two middle rows) slicing through the memory space. In a second embodiment, when creating a non-slice submatrix 352, row pointers may be reused (i.e., again, because the child object shares the left-most column with the parent). Here, the new submatrix starts from an initial row-ordered column boundary. In a third embodiment, a 1-dimensional subvector slice 353 may not reuse parent row pointers (i.e., because it does not juxtapose any portions of the left-most column). However, as there is only one row pointer the raw pointer is still available. Here, the new subvector spans the interior space of the original data structure to the columnar bounds without sharing parent row pointers. In another embodiment, when creating an arbitrary submatrix 354, new row pointers would need to be allocated and there will be no access to the parent data object's raw pointer as the arbitrary bounds of the submatrix span the interior of the parent data object.

It should be noted that similar storage optimizations are available in three or more dimensions as well. An X dimension offset of zero allows row pointer reuse. Similarly, X and Y offsets of zero allow slice pointer reuse, volume pointer reuse, etc.

Determinations of Optimizations

FIG. 4 is of a logic flow diagram illustrating the vector operator's determination of optimization. In one embodiment, the vector operator employs a determination component to determine the types of optimizations that may take place from API requests. A common and costly type of operation is one where a user wishes to cause operations to a subset of an already existing data object. Prior to the vector operator in the present disclosure, there was no easy way to request such a subset data structure without creating a copy of the relevant portions of the existing data structure elsewhere in memory and/or having the user keep track of optimizations him or herself. The vector operator can make determinations to avoid such copying, and thereby greatly improve performance and efficiency while maintaining a transparent API.

In addition to the flow diagram in FIG. 4, below is a non-limiting embodiment that shows an example code implementation of a determination component for a slice as expressed in C; it should be noted that this code is not the only implementation and is provided as only one of many possible implementations, which are all contemplated as being within scope of the present disclosure. Although flow diagram Figure numbers are placed adjacent to lines of code, below, that is not to imply and/or act as limitation to the claimed inventions as many alternative embodiments are also contemplated as being within the scope and spirit of any and all claimed embodiments.

In one example embodiment of the flow diagram of optimization determination follows:

nfulldims = 0;
while (nfulldims<MAX_DIMS && dims[nfulldims] == parent-

>dims[nfulldims])

nfulldims++;

highestdim = MAX_DIMS-1;
while (dims[highestdim] == 1 && highestdim>0)

highestdim--;

| 420 | if ((nfulldims >= highestdim && raw_pointer(parent)) \|\| |
|---|---|
| | highestdim == 0) { |
| | /* possible to create a slice subvector in this case */ |
| 425* | d = mk_data(data_type(parent), xres, yres, zres, |

| | |
|---|---|
| 430 | xoffs, yoffs, zoffs, parent, false, false, true); |

| | } |
|---|---|
| | else { |
| 425* | d = mk_data(data_type(parent), xres, yres, zres, |

| | |
|---|---|
| 435 | xoffs, yoffs, zoffs, parent, false, false, false); |

| | } |
|---|---|
| where: | ″d″ is to be a newly created child object, i.e., subvector; |
| | “xoffs” is the X offset of the subvector, e.g., in an expression: |

d = v[a..b,c..d, ...]
the xoff is the value of “a”;

“yoffs” and “zoffs,” similarly, are offsets in the Y and Z
dimensions;
“xres,” “yres,” “zres” are the sizes of the X, Y and Z
dimensions;
“d−>raw” is the new subvector's raw pointer;
“d−>parent−>raw” is the original vector's raw pointer;
“nfulldims” is a counter to iterate through all the vector's
dimensions;
“highestdim” will identify the highest dimension value; and
lines 425*, in the code above, employ the API function to
invoke the creation of

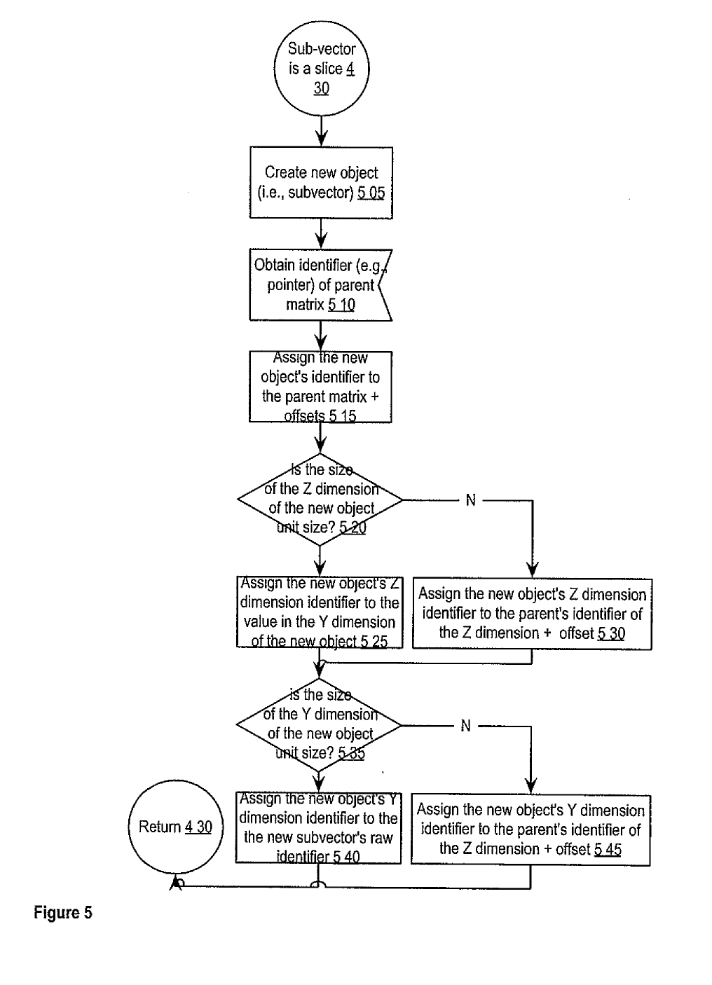

a reference subvector, e.g., a slice or arbitrary subvector, whose creation
is detailed in greater
detail in Figure 5.

The determination component will initially and/or continuously determine if there is a submitted operation for evaluation 401. A user may have supplied a parent vector having set dimensions that may be ascertained, which may be parsed into operation tokens. In one embodiment, a data object may be passed as part of a command via a supplied API. As such, upon determining that an identifier was obtained, the data identifier (i.e., pointer) may be used to determine the bounds of the memory space that it addresses 405 (i.e., as has already been discussed in FIG. 1). Further, a user may supply a request for a new subspace of the parent data object having bounds supplied as parameters 410. For example, M′=M[1 . . . 2,0 . . . 3] would be parsed identifying that M is an identifier of a parent data object. M's raw pointer may be used to identify its bounds 405 (e.g., M might occupy a 4×4 unit memory space as in 351 of FIG. 3). M′ would be parsed as a request for a new subspace with the 1.2 and 0.3 parameters specifying the dimensional subspace memory bounds (e.g., in such an example, M′ would occupy the grey portion of 351 of FIG. 3).

Having the address and the relative sizes of the parent data structure and the requested child object, the vector operator can compare the dimensions of the child and parent to confirm overlap and suitability for optimization 415. If all subvector dimensions below the highest non-unit-size subvector dimension are equal in size to the corresponding dimensions in the parent, then there is a chance for a “slice” optimization 420, otherwise, the vector operator will go on to generate an arbitrary subvector 435. A “unit” is the minimum amount of space in any direction that may be represented by a discrete grid of numbers (i.e. one number in the X direction, or one row of numbers in the Y direction); and as such, a “non-unit” is any larger section of space. In other words, if the requested subvector has non-unit-size dimensions higher than some incomplete (less than parent size) dimensions, the vector operator will consider this to be an arbitrary subvector 435. Thereafter 420, the vector operator will determine if the parent is a full vector or just a slice 425. If the parent is either a slice or full vector 425, then the vector operator will go about creating a slice subvector 435, otherwise, an arbitrary subvector will be made 435. The determination component will then see if there are other operation tokens enqueued 440, and if not, it may terminate 445; otherwise the determination component may go on to work on the next operation token 401. In such a manner, the vector operator may create a reference subvector either through a slice or arbitrary subvector.

Slice Optimization

FIG. 5 is of a logic flow diagram illustrating the vector operator's slice optimization. As was discussed 420, 425 in FIG. 4, a slice is a special case that occurs when creating a subvector. In one embodiment, a slice is a subvector of an N-dimensional vector that is the same size as the parent vector in its first N−1 dimensions; e.g., a cross-section of a volume dataset.

In one embodiment, when the highest non-unit-size dimension of the subvector is the only dimension smaller than its corresponding dimension in the parent vector, the data for the subvector is contiguous in memory. In this situation, the representation of the subvector is the same as that of an ordinary vector and no special code is required. This holds true for a 1-dimensional subvector as well. Also, this scheme applies to “thick” slices; i.e., a slice of greater than unit size in its highest dimension, e.g., a contiguous series of 2-dimensional slices in a volume dataset.

In addition to the flow diagram in FIG. 5, below is a non-limiting embodiment that shows an example code implementation to create a slice as expressed in C; it should be noted that this code is not the only implementation and is provided as only one of many possible implementations, which are all contemplated as being within scope of the present disclosure. Although flow diagram Figure numbers are placed adjacent to lines of code, below, that is not to imply and/or act as limitation to the claimed inventions as many alternative embodiments are also contemplated as being within the scope and spirit of any and all claimed embodiments.

In one example embodiment of the flow diagram, a raw pointer and row pointers are assigned to a slice subvector as follows:

d−>raw = d−>parent−>raw +

| 515 | (xoffs + d−>parent−>xres * (yoffs + d−>parent−>yres * |
|---|---|
| | zoffs)) * size; |

| | |
|---|---|
| 520 | if (d−>zres == 1) { |

| | |
|---|---|
| 525 | d−>zdata = &d−>ydata; |

}
else {

| 530 | d−>zdata = d−>parent−>zdata + zoffs; |
|---|---|
| | return; |

| | } |
|---|---|
| 535 | if (d−>yres == 1) { |

| | |
|---|---|
| 540 | d−>ydata = &d−>raw; |

}
else {

| | |
|---|---|
| 545 | d−>ydata = d−>parent−>zdata[zoffs] + yoffs; |

| | } |
|---|---|
| where: | ″d″ is a newly created child object, i.e., subvector; |
| | “xoffs” is the X offset of the subvector, e.g., in an expression: |

d = v[a..b,c..d, ...]
the xoff is the value of “a”;

“yoffs” and “zoffs,” similarly, are offsets in the Y and Z
dimensions;
“size” is the size of a single data element;
“d−>xres,” “d−>yres,” “d−>zres” are the sizes of the X, Y and
Z dimensions in the

subvector;

“d−>parent−>xres,” “d−>parent−>yres,” “d−>parent−>zres are
the sizes of the X,

Y, and Z dimensions in the parent;

“d−>raw” is the new subvector's raw pointer;
“d−>parent−>raw” is the original vector's raw pointer; and
“d−>zdata” and “d−>ydata” are two extra pointers that may be
used to represent

the Z and/or Y dimensions when Y is unit size or both Y and Z are unit
size (i.e., these represent
the Y or Y and Z dimensions in the case where one or both dimensions
are unit-size).

Upon determining that a slice optimization may take place 430, the vector operator may create a child object 505. For example, the object may be a child subvector as was specified by a user request, which is to work with a subset of a parent data structure. The slice optimization will then take the identifier of the parent data structure it was supplied (e.g., via a user employing an API that requests a new subvector) 510. At that point, the vector operator may assign the child slice object's identifier to the parent's identifier plus various offsets 515.

Upon assigning the new slice object's offsets 515, the vector operator will determine if the size of the Z dimension of the new object is unitary in size 520. If it is, then the vector operator assigns the new object's Z dimension identifier to the value in the Y dimension of the new object 525, otherwise, the vector operator assigns the new object's Z dimension identifier to the parent's identifier of the Z dimension plus an offset 530. In either case 525, 530, the vector operator will determine if the size of the Y dimension of the new object is unitary in size 535. If the Y dimension is unitary 535, then the vector operator assigns the slice object's Y dimension's identifier to the new slice object's raw identifier 540; otherwise 535, the vector operator assigns the slice object's Y dimension identifier to the parent's identifier of the Z dimension plus and offset 545. In either case 540, 545, the vector operator may return control to any engaging component 430.

As a result, no space for new row pointers needed to be allocated. Instead, Y and Z pointers are set to reference appropriate parts of the pointer arrays, which are referenced by the parent vector's Y and Z pointers.

Arbitrary Optimization

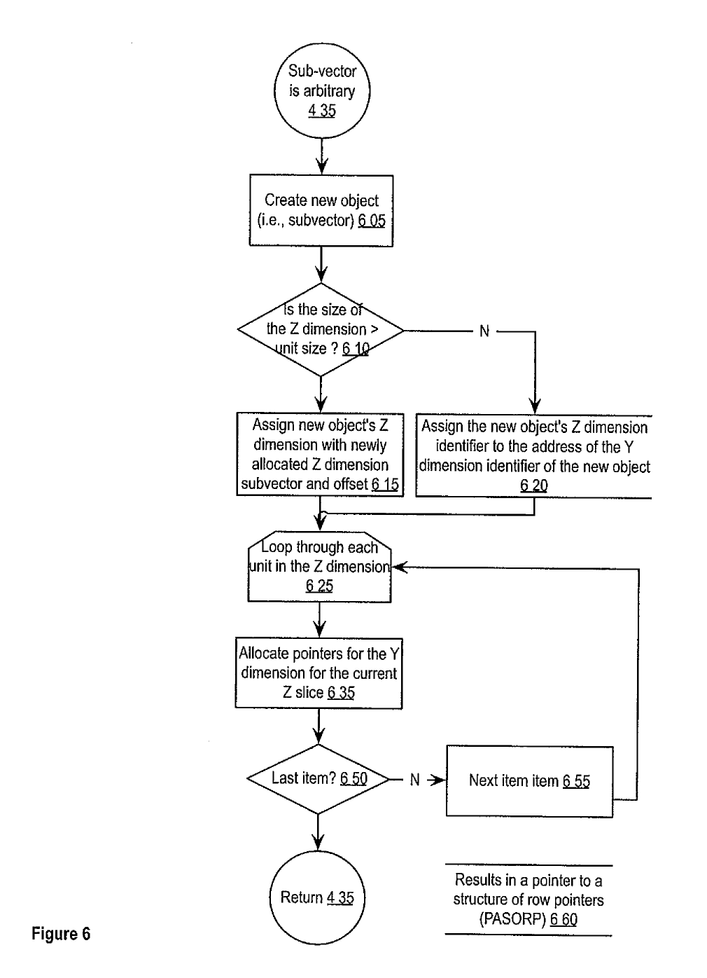

FIG. 6 is of a logic flow diagram illustrating the vector operator's arbitrary vector optimization. In the case of arbitrary subvectors, new row (and possibly slice) pointers may be allocated. In one embodiment, row pointers are initialized relative to their corresponding pointers in the parent vector, adding appropriate offsets.

In addition to the flow diagram in FIG. 6, below is a non-limiting embodiment that shows an example code implementation to create an arbitrary subvector as expressed in C; it should be noted that this code is not the only implementation and is provided as only one of many possible implementations, which are all contemplated as being within scope of the present disclosure. Although flow diagram Figure numbers are placed adjacent to lines of code, below, that is not to imply and/or act as limitation to the claimed inventions as many alternative embodiments are also contemplated as being within the scope and spirit of any and all claimed embodiments.

In one example embodiment of the flow diagram, both subvectors and ordinary vectors may be created as follows:

| | |
|---|---|
| 610 | if(zres > 1) { |

d−>zdata = malloc(zres * sizeof(void**));

}
else {

d−>zdata = &d−>ydata;

| | } |
|---|---|
| 625 | for (z=0; z < zres; z++) { |

| | |
|---|---|
| 610 | if (yres > 1 \|\| zres > 1) { |

d−>zdata[z] = malloc(yres * sizeof(void*));
if (CREATING SUBVECTOR) {

for (y=0; y < yres; y++) {

| | |
|---|---|
| 615 | d−>zdata[z][y] = |

d−>parent−>zdata[z+zoffs][y+yoffs] +

xoffs*size;

}

}
else {

for (y=0; y < yres; y++) {

d−>zdata[z][y] = d−>raw +

(xoffs + 0 + xres *
(yoffs + y + yres *
(zoffs + z))) * size;

}

}

}
else {

d−>zdata[z] = &d−>raw;

}

| | } |
|---|---|
| where: | “y” and “z” are temporary variables. |

Upon determining that an arbitrary optimization may take place 435, the vector operator may create a new object 605. For example, the object may be a new subvector as was specified by a user request, which is to work with a subset of a parent data structure. The vector operator will determine if the size of the Z dimension of the arbitrary object is unitary in size 610. If it is, then the vector operator assigns the arbitrary object's Z dimension identifier to the newly allocated Z dimension subvector 615 plus an offset, otherwise, the vector operator assigns the arbitrary object's Z dimension identifier to the Y dimension identifier of the arbitrary object 620. In either case 615, 620, the vector operator will examine each unit in the Z dimension of the arbitrary object 625. For each such unit 625, the vector operator allocates identifiers for the Y dimension for the current Z slice 635. If this is not the last item that needs to be examined 650, the vector operator will go on to examine the next item 655, 625; otherwise, the vector operator may return control to any engaging component 435. Upon returning control, a PASORP 660 will be provided back to any engaging component.

Distributed Vector Operations

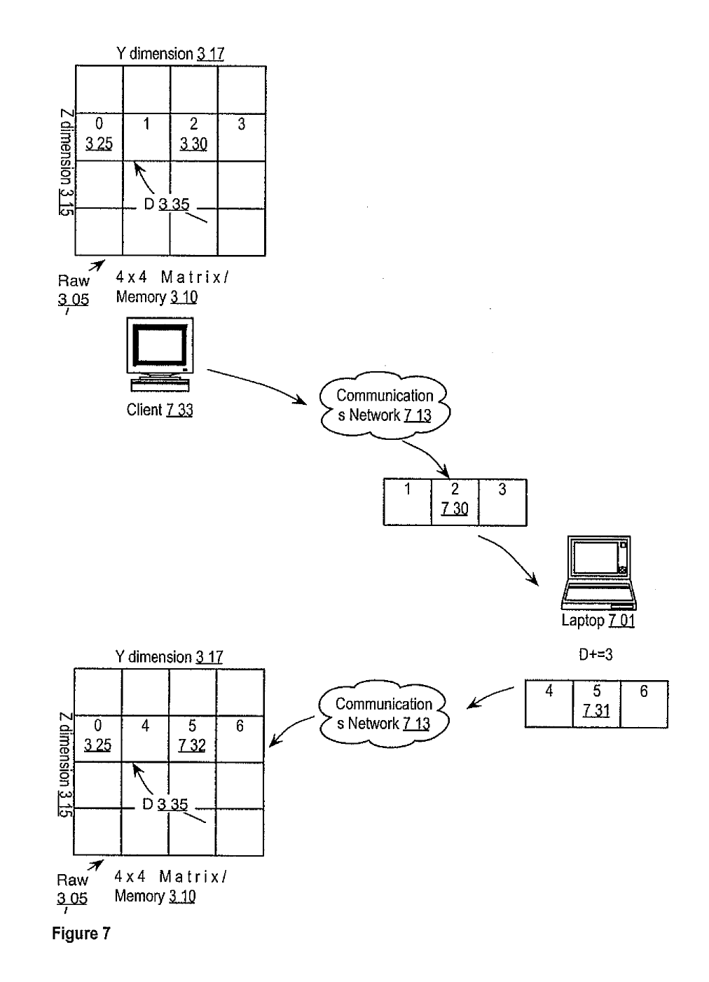

FIG. 7 is of a block diagram illustrating the vector operator in a distributed environment. In one embodiment, a client 733 employing the vector operator may have a vector 305 in its memory 310 (as has already been discussed in FIG. 3). By engaging the vector operator, a user either at the client 733 or at another client 701 across a communications network 713 may cause the client to distribute its data so as to share a computational burden. Rather than sending the entire dataset 310, the vector operator, instead, sends only a subvector 330 through the communications network 730, which is then received by another client. The other client's own vector operator lets it perform operations on the received subvector 730, e.g., D+=3 would add 3 to the values in the subvector 730, which would result in a modified subvector 731. When the other client 701 has finished its computations, it may then send the modified subvector back across the communications network to the original client 733. Upon receiving the modified subvector, the originating client's 733 vector operator will update its dataset's 305 memory reflecting the updates to the subvector 732. With such a scheme, only the subvector 730 is sent to and back 731 from the assisting clients, thereby reducing data transfers. In addition, it allows for greater distributed processing which can thereby increase computational speed and/or efficiency.

The vector operator provides API operators to enable such remote operations, which includes:

remote_reference is a reference to an object on a remote machine;

realize(r) is an operation on a remote reference that causes the remote object's contents to be transferred to the local machine;

remote_apply(connection, function, argument-list) is an instruction to a remote machine to invoke a certain functions on certain arguments. For example, arguments that are remote references are resolved to ordinary values on the receiving end, and arguments that are ordinary values are sent to the remote machine. remote_apply( ) yields a remote reference to the result.

In a distributed computing system with remote references, any given object may be sent over the network by value or by reference. In some cases where a reference subvector needs to be sent by value, the vector operator is able to avoid network traffic in a way analogous to avoiding copying when a reference subvector is created on the local machine. If the data for the parent of a reference subvector has already been sent to the receiving machine, there is no need to send the data for the subvector, since the receiving machine may instead be told to look it up out of the already-sent parent. In one embodiment, to enable this optimization, the original data may be copied using a realize_readonly(r) call, which indicates that the machine receiving data intends not to modify it. This is useful in a frequent situation where a distributed computation begins by sending the input data to all machines involved. Algorithms usually need to access the input data many times, so it is worthwhile to send all the data in advance so subsequent accesses take place locally rather than over the network. In one embodiment, the data transfer may be accomplished via an HTTP post command. In another embodiment, a port may be opened on both client computers and a TCP/IP connection may be established to send data between the computers in packet and/or stream form.

As such, an advantage of this distributed vector operator is that when one machine asks another to operate on some data, e.g., a matrix, the distributed vector operator knows whether the matrix is actually a submatrix, and as such, automatically, is able to avoid sending data when possible. The programmer does not need to code with an awareness of which matrices refer to already-sent data and which do not. This makes it possible to write routines that are completely generic and yet retain good performance for computations that can be optimized to avoid redundant sending.

The vector operator, having so many advantages, is particularly useful in developing algorithms for linear algebra that work on blocks of a matrix (submatrices). Also, it is ideal for working with slices of data, e.g. in medical imaging. Another use of the vector operator is to optimize copying operations indicated by a user of the programming system; for example:
a[0 . . . 100]=a[1 . . . 101]
shifts elements of the vector “a” in constant space (i.e., without using additional memory).
Vector Operator Controller

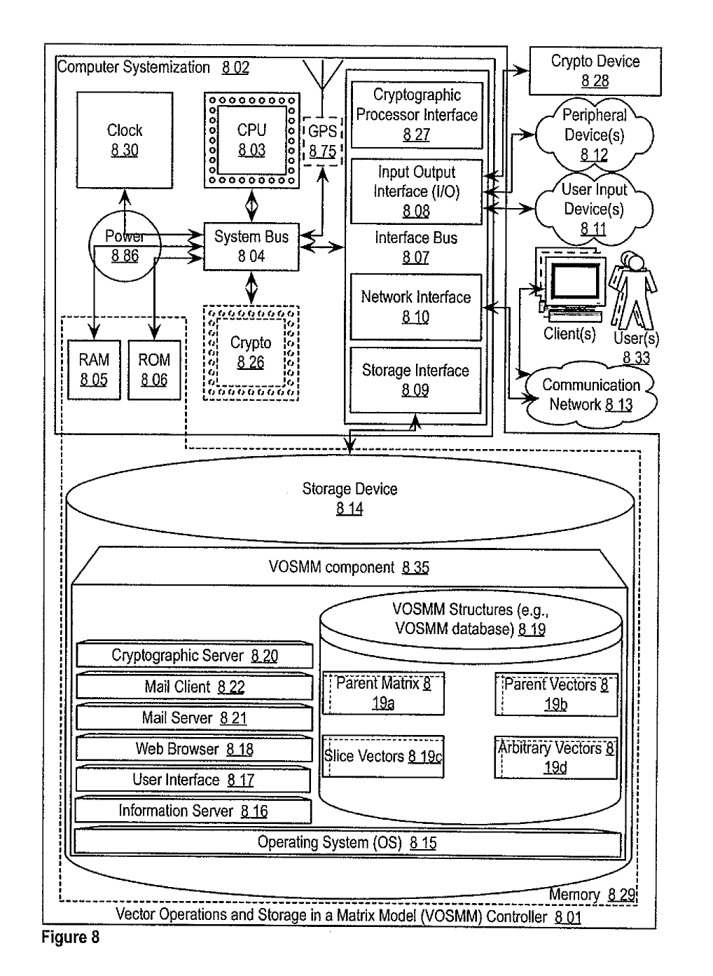

FIG. 8 of the present disclosure illustrates inventive aspects of a vector operator controller 801 in a block diagram. In this embodiment, the vector operator controller 801 may serve to access, calculate, generate, identify, instruct, match, process, search, serve, and/or store, and/or vectors in matrix models.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. CPUs use communicative signals to enable various operations. Such communicative signals may be stored and/or transmitted in batches as program and/or data components that facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

In one embodiment, the vector operator controller 801 may be connected to and/or communicate with entities such as, but not limited to: one or more users from user input devices 811; peripheral devices 812; a cryptographic processor device 828; and/or a communications network 813.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The vector operator controller 801 may be based on common computer systems that may comprise, but are not limited to, components such as: a computer systemization 802 connected to memory 829.

Computer Systemization

A computer systemization 802 may comprise a clock 830, central processing unit (CPU) 803, a read only memory (ROM) 806, a random access memory (RAM) 805, and/or an interface bus 807, and most frequently, although not necessarily, are all interconnected and/or communicating through a system bus 804. Optionally, the computer systemization may be connected to an internal power source 886. Optionally, a cryptographic processor 826 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the vector operator controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

Power Source

The power source 886 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 886 is connected to at least one of the interconnected subsequent components of the vector operator thereby providing an electric current to all subsequent components. In one example, the power source 886 is connected to the system bus component 804. In an alternative embodiment, an outside power source 886 is provided through a connection across the I/O 808 interface. For example, a USB and/or IEEE 1394 connection carries both data and power across the connection and is therefore a suitable source of power.

Interface Adapters

Interface bus(ses) 807 may accept, connect, and/or communicate to a number of interface adapters, conventionally although not necessarily in the form of adapter cards, such as but not limited to: input output interfaces (I/O) 808, storage interfaces 809, network interfaces 810, and/or the like. Optionally, cryptographic processor interfaces 827 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 809 may accept, communicate, and/or connect to a number of storage devices such as, but not limited to: storage devices 814, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 810 may accept, communicate, and/or connect to a communications network 813. Through a communications network 113, the vector operator controller is accessible through remote clients 833b (e.g., computers with web browsers) by users 833a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 810 may be used to engage with various communications network types 813. For example, multiple network interfaces may be employed to allow for the communication over broadcast, multicast, and/or unicast networks.

Input Output interfaces (I/O) 808 may accept, communicate, and/or connect to user input devices 811, peripheral devices 812, cryptographic processor devices 828, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set 145, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 811 may be card readers, dongles, finger print readers, gloves, graphics tablets, joysticks, keyboards, mouse (mice), remote controls, retina readers, trackballs, trackpads, and/or the like.

Peripheral devices 812 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the vector operator controller may be embodied as an embedded, dedicated, and/or monitor-less (i.e., headless) device, wherein access would be provided over a network interface connection.

Cryptographic units such as, but not limited to, microcontrollers, processors 826, interfaces 827, and/or devices 828 may be attached, and/or communicate with the vector operator controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

Memory

Generally, any mechanization and/or embodiment allowing a processor to affect the storage and/or retrieval of information is regarded as memory 829. However, memory is a fungible technology and resource, thus, any number of memory embodiments may be employed in lieu of or in concert with one another. It is to be understood that the vector operator controller and/or a computer systemization may employ various forms of memory 829. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 829 will include ROM 806, RAM 805, and a storage device 814. A storage device 814 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); an array of devices (e.g., Redundant Array of Independent Disks (RAID)); and/or other devices of the like. Thus, a computer systemization generally requires and makes use of memory.

Component Collection

The memory 829 may contain a collection of program and/or database components and/or data such as, but not limited to: operating system component(s) 815 (operating system); information server component(s) 816 (information server); user interface component(s) 817 (user interface); Web browser component(s) 818 (Web browser); database(s) 819; mail server component(s) 821; mail client component(s) 822; cryptographic server component(s) 820 (cryptographic server); the vector operator component(s) 835; and/or the like (i.e., collectively a component collection). These components may be stored and accessed from the storage devices and/or from storage devices accessible through an interface bus. Although non-conventional program components such as those in the component collection, typically, are stored in a local storage device 814, they may also be loaded and/or stored in memory such as: peripheral devices, RAM, remote storage facilities through a communications network, ROM, various forms of memory, and/or the like.

Operating System

The operating system component 815 is an executable program component facilitating the operation of the vector operator controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the vector operator controller to communicate with other entities through a communications network 813. Various communication protocols may be used by the vector operator controller as a subcarrier transport mechanism for interaction, such as, but not limited to: multicast, TCP/IP, UDP, unicast, and/or the like.

Information Server

An information server component 816 is a stored program component that is executed by a CPU. The information server may be a conventional Internet information server such as, but not limited to Apache Software Foundation's Apache, Microsoft's Internet Information Server, and/or the. The information server may allow for the execution of program components through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the vector operator controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the vector operator structure 819, operating systems, other program components, user interfaces, Web browsers, and/or the like.

Access to the vector operator structure may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Vector operator. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the vector operator as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface component 817 is a stored program component that is executed by a CPU. The user interface may be a conventional graphic user interface as provided by, with, and/or atop operating systems and/or operating environments such as Apple Macintosh OS, e.g., Aqua, GNUSTEP, Microsoft Windows (NT/XP), Unix X Windows (KDE, Gnome, and/or the like), mythTV, and/or the like. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component 818 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the vector operator enabled nodes. The combined application may be nugatory on systems employing standard Web browsers.

Mail Server

A mail server component 821 is a stored program component that is executed by a CPU. The mail server may be a conventional Internet mail server such as, but not limited to sendmail, Microsoft Exchange, and/or the. The mail server may allow for the execution of program components through facilities such as ASP, ActiveX, (ANSI) (Objective-) C (++), CGI scripts, Java, JavaScript, PERL, pipes, Python, WebObjects, and/or the like. The mail server may support communications protocols such as, but not limited to: Internet message access protocol (IMAP), Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the vector operator.

Access to the vector operator mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component 822 is a stored program component that is executed by a CPU. The mail client may be a conventional mail viewing application such as Apple Mail, Microsoft Entourage, Microsoft Outlook, Microsoft Outlook Express, Mozilla Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component 820 is a stored program component that is executed by a CPU 803, cryptographic processor 826, cryptographic processor interface 827, cryptographic processor device 828, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the vector operator may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the vector operator component to engage in secure transactions if so desired. The cryptographic component facilitates the secure accessing of resources on the vector operator and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Vector Operator Structure

The vector operator structure component 819 may be embodied in as a data-structure and/or database and its stored data. In the case of a data-structure, the structure is a configured memory space where the vector operator component configures the CPU to access and process the structured memory space. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the vector operator structure and/or database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the vector operator structure is implemented as a data-structure, the use of the vector operator structure 819 may be integrated into another component such as the vector operator component 835. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the structured component 819 includes several memory allocations (e.g., tables) 819a-d. A parent matrix table 819a includes fields such as, but not limited to: an identifier to a memory space, indices to the bounds of the memory space, and/or the like. A parent vectors table 819c includes fields such as, but not limited to: an identifier to a parent matrix, an identifier to parent vectors, indices to the bounds of the parent vectors, and/or the like. A slice vector table 819c includes fields such as, but not limited to: an identifier to a parent structure, an identifier to the slice vector, indices to the bounds of the slice vector. An arbitrary vector table 819d includes fields such as, but not limited to: an identifier to a parent structure, an identifier to the arbitrary vector, indices to the bounds of the arbitrary vector.

In one embodiment, the vector operator structure may interact with other data-structure and/or database systems. For example, employing a distributed database system, queries and data access by the vector operator components may treat the combination of the vector operator and vector operator structure as a single entity.

In one embodiment, user programs may contain various user interface primitives, which may serve to update the vector operator. Also, various configurations may require custom structures depending upon the environments and the types of clients and/or operations the vector operator may need to satisfy. It should be noted that any unique fields may be designated as a key field throughout. In an alternative embodiment, these tables have been decentralized into their own structures and/or databases and their respective structure and/or database controllers (e.g., individual database controllers for each of the above tables). One may further distribute the structures, identifiers to the structures and/or databases over several computer systemizations and/or storage devices. Similarly, configurations of the decentralized database controllers may be varied by consolidating and/or distributing the various database components 819a-d. The vector operator may be configured to keep track of various settings, inputs, and parameters via database controllers.

The vector operator structure may communicate to and/or with other components in a component collection, including itself, and/or facilities of the like. Most frequently, the vector operator structure communicates with the vector operator component, other program components, and/or the like. The database may contain, retain, and provide information regarding other nodes and data.

The Vector Operator

The vector operator component 835 is a stored program component that is executed by a CPU. The vector operator affects accessing, obtaining and the provision of information, services, transactions, and/or the like across various communications networks.

The vector operator component enables the access, calculation, generation and manipulation of vectors in matrix models in an easy and efficient manner. In one embodiment, the vector operator component may be accessed through manifold channels. Via the API, the vector operator component may interface with any number of front ends and/or back end systems. In one embodiment, the vector operator component may operate as its own process, e.g., as a server process, whereby it is listening for communications on a port address. In such an embodiment, the vector operator component may obtain API and/or other requests to perform operations from clients and/or other instances of vector operator components. Once the vector operator component obtains a request, it can process any obtained expressions and/or tokens in a number of ways. In one embodiment, interpretation takes place interactively. In another embodiment, expressions and/or tokens are compiled to a code representation for processing; for example, expressions may be compiled into a machine code, a specialized vector instruction set like those found on modern processors (e.g., Altivec on PowerPC architectures, and MMX/SSE on Intel architectures), and/or the like.

The vector operator component enabling access of information between nodes may be developed by employing standard development tools such as, but not limited to: (ANSI) (Objective-) C (++), Apache components, binary executables, database adapters, Java, JavaScript, mapping tools, procedural and object oriented development tools, PERL, Python, shell scripts, SQL commands, web application server extensions, WebObjects, and/or the like. In one embodiment, the vector operator server employs a cryptographic server to encrypt and decrypt communications. The vector operator component may communicate to and/or with other components in a component collection, including itself, and/or facilities of the like. Most frequently, the vector operator component communicates with the vector operator structure, operating systems, other program components, and/or the like. The vector operator may contain, communicate, generate, obtain, and/or provide program component, system, user, and/or data communications, requests, and/or responses.

Distributed Vector Operator

The structure and/or operation of any of the vector operator node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the vector operator controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged recognize the tokens of an HTTP post command, e.g.:

w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. Further, section headings within the disclosure, including claim labels and sub-part labels, should not be construed as being limiting in arrangement, composition, function, logic, organization, sequence, structure, topology, and/or the like. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and arrangement, composition, functional, logical, organizational, sequential, structural, topological, and/or the like modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, arrangements, compositions, embodiments, examples, functional, features, logical, organizational, sequential, structural, topological, and/or other aspects of the disclosure are not to be considered limitations on the disclosure as defined by the claims or limitations on equivalents to the claims.

What is claimed is:

1. A processor-implemented method to access data, comprising:
a) generating a first set of data in a first region, if no first set of data exists;
b) obtaining dimensions of the first region;
c) obtaining an expression to perform a computation on a set of data related to the first set of data,
wherein the expression refers to a portion of the first set of data,
wherein the expression abides by an application programming interface;
d) identifying a region to be used by the related set of data from the obtained expression's reference to the portion of the first data set;
e) obtaining an identifier for the first region;
f) obtaining dimensions of related region;
g) determining if the related region fits within the first region,
wherein a fit occurs if the related region's highest dimension size is less in size than the first region's corresponding dimension size,
wherein the determination includes:
i) comparing dimensions of the related region to the first region,
wherein the comparison is if a highest non-unit sized dimension of the related region is less than a size of corresponding dimensions of the first region;
h) generating at least one identifier that references the related region, if the related region fits within the first region,
wherein a single identifier referencing the related region is generated if the first region is one of a slice and full vector;
wherein the generation of at least one identifier includes:
i) assigning the identifier of the related region by setting it to the first region's identifier plus an offset,
wherein the assignment's offset takes the form of:
d−>raw=d−>parent−>raw+(xoffs+d−>parent−>xres*(yoffs+d−>parent−>yres*zoffs))*size;
ii) determining if a first dimension of the assigned identifier is of unit size;
iii) assigning a first dimension identifier for the related region to a value in a corresponding second dimension of the related region, if the first dimension of the assigned identifier is determined to be of unit size,
wherein the first dimension of the identifier for the related region is a Z dimension and the assignment is made to the value in a Y dimension of the related region;
iv) assigning a first dimension identifier for the related region to a corresponding first dimension of the first region plus an offset, if the first dimension of the assigned identifier is determined to not be of unit size,
wherein the first dimension of the identifier for the related region is a Z dimension and the assignment is made to the first region identifier of a Z dimension,
wherein the assignment's offset takes the form of:
d−>zdata=d−>parent−>zdata+zoffs;
v) determining if a second dimension of the assigned identifier is of unit size;
vi) assigning a second dimension identifier for the related region to a the identifier for the related region, if the second dimension of the assigned identifier is determined to be of unit size,
wherein the second dimension of the identifier for the related region is a Y dimension;
vii) assigning a second dimension identifier for the related region to a corresponding first dimension of the first region plus an offset, if the second dimension of the assigned identifier is determined to not be of unit size,
wherein the first dimension of the identifier for the related region is a Z dimension and the assignment is made to related region identifier of a Z dimension,
wherein the assignment's offset takes the form of:
d−>ydata=d−>parent−>zdata[zoffs]+yoffs;
j) generating a plurality of identifiers, if the related region is arbitrary;
wherein the generation of a plurality of identifiers includes:
i) determining if a size of a first dimension of the related region is greater than unit size;
ii) assigning a first dimension identifier for the related region to the first dimension of the first region plus an offset, if the first dimension of the assigned identifier is determined to be of unit size,
wherein the first dimension of the identifier for the related region is a Z dimension and the assignment is made to related region identifier of a Z dimension,
wherein the assignment's offset takes the form of:
d−>zdata[z][y]=d−>parent−>zdata[z+zoffs][y+yoffs]+xoffs*size;
iii) assigning a first dimension identifier for the related region to an address in a corresponding second dimension of the related region, if the first dimension of the assigned identifier is determined to not be of unit size,
wherein the first dimension of the identifier for the related region is a Z dimension and the assignment is made to the address in a Y dimension of the related region;
iv) allocating identifiers for a second dimension for a current dimension slice, wherein allocation of identifiers is made for each unit in the current dimension,
wherein the current dimension of the slice is a Z dimension and the allocation is made to a Y dimension;
k) returning any generated identifiers,
wherein the returned identifiers are returned to the referring expression,
wherein the identifiers seemingly have characteristics of being an independent set of data,
wherein changes to the related set of data through the identifier affect the first set of data, and
wherein changes to the first set of data affect the related set of data.

2. A processor-implemented method to access data, comprising:
a) generating a first set of data in a first region, if no first set of data exists;
b) obtaining dimensions of the first region;
c) obtaining an expression to perform a computation on a set of data related to the first set of data,
wherein the expression refers to a portion of the first set of data,
wherein the expression abides by an application programming interface;
d) identifying a region to be used by the related set of data from the obtained expression's reference to the portion of the first data set;
e) obtaining an identifier for the first region;
f) obtaining dimensions of related region;
g) determining if the related region fits within the first region,
wherein a fit occurs if the related region's highest dimension size is less in size than the first region's corresponding dimension size,
wherein the determination includes:
i) comparing dimensions of the related region to the first region,
wherein the comparison is if a highest non-unit sized dimension of the related region is less than a size of corresponding dimensions of the first region;
h) generating at least one identifier that references the related region, if the related region fits within the first region,
wherein a single identifier referencing the related region is generated if the first region is one of a slice and full vector,
wherein the generation of at least one identifier includes:
i) assigning the identifier of the related region by setting it to the first region's identifier plus an offset;
ii) determining if a first dimension of the assigned identifier is of unit size;
iii) assigning a first dimension identifier for the related region to a value in a corresponding second dimension of the related region, if the first dimension of the assigned identifier is determined to be of unit size;
iv) assigning a first dimension identifier for the related region to a corresponding first dimension of the first region plus an offset, if the first dimension of the assigned identifier is determined to not be of unit size;
v) determining if a second dimension of the assigned identifier is of unit size;
vi) assigning a second dimension identifier for the related region to a the identifier for the related region, if the second dimension of the assigned identifier is determined to be of unit size;
vii) assigning a second dimension identifier for the related region to a corresponding first dimension of the first region plus an offset, if the second dimension of the assigned identifier is determined to not be of unit size;
j) generating a plurality of identifiers, if the related region is arbitrary;
wherein the generation of a plurality of identifiers includes:
i) determining if a size of a first dimension of the related region is greater than unit size;
ii) assigning a first dimension identifier for the related region to the first dimension of the first region plus an offset, if the first dimension of the assigned identifier is determined to be of unit size;
iii) assigning a first dimension identifier for the related region to an address in a corresponding second dimension of the related region, if the first dimension of the assigned identifier is determined to not be of unit size;
iv) allocating identifiers for a second dimension for a current dimension slice, wherein allocation of identifiers is made for each unit in the current dimension;
k) returning any generated identifiers,
wherein the returned identifiers are returned to the referring expression,
wherein the identifiers seemingly have characteristics of being an independent set of data,
wherein changes to the related set of data through the identifier affect the first set of data, and
wherein changes to the first set of data affect the related set of data.

3. A processor-implemented method to access data, comprising:
obtaining dimensions of a first region;
obtaining an expression to perform a computation on a set of data related to a first set of data in the first region;
identifying a region to be used by the related set of data from the obtained expression;
determining if the related region fits within the first region;
generating at least one identifier that references the related region, if the related region fits within the first region;
generating a plurality of identifiers, if the related region is arbitrary.

4. The method of claim 3, further, comprising:
generating a first set of data in a first region, if no first set of data exists.

5. The method of claim 3, wherein the expression refers to a portion of the first set of data.

6. The method of claim 3, wherein the expression abides by an application programming interface.

7. The method of claim 3, wherein the identification of the region to be used by the related set of data from the obtained expression's reference to the portion of the first data set.

8. The method of claim 3, further, comprising:
obtaining an identifier for the first region.

9. The method of claim 3, further, comprising:
obtaining dimensions of related region.

10. The method of claim 3, wherein a fit occurs if part of the related region falls within the first region and another part does not fit.

11. The method of claim 10, wherein another set of data is generated in another subsequent region and the last data element that fit within the first region is provided a reference to the subsequent region.

12. The method of claim 3, wherein a fit occurs if the related region's highest dimension size is less in size than the first region's corresponding dimension size.

13. The method of claim 12, wherein the determination includes comparing dimensions of the related region to the first region.

14. The method of claim 13, wherein the comparison is if a highest non-unit sized dimension of the related region is less than a size of corresponding dimensions of the first region.

15. The method of claim 3, wherein a single identifier referencing the related region is generated if the first region is one of a slice and full vector.

16. The method of claim 3, wherein the generation of at least one identifier includes:
assigning the identifier of the related region by setting it to the first region's identifier plus an offset.

17. The method of claim 16, wherein the assignment's offset takes the form of:
d−>raw=d−>parent−>raw+(xoffs+d−>parent−>xres*(yoffs+d−>parent−>yres*zoffs))*size.

18. The method of claim 16, wherein the generation of at least one identifier further includes:
determining if a first dimension of the assigned identifier is of unit size;
assigning a first dimension identifier for the related region to a value in a corresponding second dimension of the related region, if the first dimension of the assigned identifier is determined to be of unit size.

19. The method of claim 18, wherein the first dimension of the identifier for the related region is a Z dimension and the assignment is made to the value in a Y dimension of the related region.

20. The method of claim 18, wherein the generation of at least one identifier further includes:
assigning a first dimension identifier for the related region to a corresponding first dimension of the first region plus an offset, if the first dimension of the assigned identifier is determined to not be of unit size.

21. The method of claim 20, wherein the first dimension of the identifier for the related region is a Z dimension and the assignment is made to the first region identifier of a Z dimension.

22. The method of claim 21, wherein the assignment's offset takes the form of:
d−>zdata=d−>parent−>zdata+zoffs.

23. The method of claim 20, wherein the generation of at least one identifier further includes:
determining if a second dimension of the assigned identifier is of unit size;
assigning a second dimension identifier for the related region to a the identifier for the related region, if the second dimension of the assigned identifier is determined to be of unit size.

24. The method of claim 23, wherein the second dimension of the identifier for the related region is a Y dimension.

25. The method of claim 23, wherein the generation of at least one identifier further includes:
assigning a second dimension identifier for the related region to a corresponding first dimension of the first region plus an offset, if the second dimension of the assigned identifier is determined to not be of unit size.

26. The method of claim 25, wherein the first dimension of the identifier for the related region is a Z dimension and the assignment is made to related region identifier of a Z dimension.

27. The method of claim 25, wherein the assignment's offset takes the form of:
d−>ydata=d−>parent−>zdata[zoffs]+yoffs.

28. The method of claim 3, wherein the generation of a plurality of identifiers includes:
determining if a size of a first dimension of the related region is greater than unit size;
assigning a first dimension identifier for the related region to the first dimension of the first region plus an offset, if the first dimension of the assigned identifier is determined to be of unit size.

29. The method of claim 28, wherein the first dimension of the identifier for the related region is a Z dimension and the assignment is made to related region identifier of a Z dimension.

30. The method of claim 29, wherein the assignment's offset takes the form of:
d−>zdata[z][y]=d−>parent−>zdata[z+zoffs][y+yoffs]+xoffs*size.

31. The method of claim 28, wherein the generation of a plurality of identifiers further includes:
assigning a first dimension identifier for the related region to an address in a corresponding second dimension of the related region, if the first dimension of the assigned identifier is determined to not be of unit size.

32. The method of claim 31, wherein the first dimension of the identifier for the related region is a Z dimension and the assignment is made to the address in a Y dimension of the related region.

33. The method of claim 31, wherein the generation of a plurality of identifiers further includes:
allocating identifiers for a second dimension for a current dimension slice, wherein allocation of identifiers is made for each unit in the current dimension.

34. The method of claim 33, wherein the current dimension of the slice is a Z dimension and the allocation is made to a Y dimension.

35. The method of claim 3, wherein the returned identifiers are returned to the referring expression.

36. The method of claim 3, wherein the identifiers seemingly have characteristics of being an independent set of data.

37. The method of claim 3, wherein changes to the related set of data through the identifier affect the first set of data.

38. The method of claim 3, wherein changes to the first set of data affect the related set of data.

39. The method of claim 3, further, comprising:
returning any generated identifiers.

40. The method of claim 39, wherein the expression is provided from across a communications network.

41. The method of claim 39, wherein the generated identifiers are returned across a communications network.

42. A processor-implemented method to generate a data structure in memory, comprising:
generating instruction signals, wherein the signal states embody a data structure having interrelated data types for:
a pointer to a data set;
a field to identify a size of each dimension for the data set;
a pointer to a parent vector, whereby the parent pointer is a self-pointer when there is no reference subvector;
a pointer to a structure of row pointers;
a first-dimension pointer and a second-dimension pointer if the second-dimension of the data set is unit size;
a field for numeric data points.

43. The method of claim 42, a field for a requested expression resolution.

44. The method of claim 43, a field with an IP address for an entity requesting an expression result.

45. A processor-implemented method to generate an interaction interface in memory, comprising:
generating instruction signals, wherein the interaction interface is responsive to user and system event signals and wherein the instruction signals are issueable by a processor for invoking:
a widget to accept a pointer to a data set;
a widget to accept a field to identify a size of each dimension for the data set;
a widget to accept a pointer to a parent vector, whereby the parent pointer is a self-pointer when there is no reference subvector;
a widget to accept a pointer to a structure of row pointers.
a widget to accept a first-dimension pointer and a second-dimension pointer if the second-dimension of the data set is unit size.
a widget to accept a field for numeric data points.

46. The method of claim 45, a field for a requested expression resolution.

47. The method of claim 46, a field with an IP address for an entity requesting an expression result.
